(19) United States
(12) Patent Application Publication
(10) Pub. No.: US 2014/0227383 A1
(43) Pub. Date: Aug. 14, 2014

(54) EXTRUDER

(71) Applicant: Thermo Electron (Karlsruhe) GmbH, Karlsruhe (DE)

(72) Inventor: Peter Roberts, Stone Staffordshire (GB)

(21) Appl. No.: 14/346,956

(22) PCT Filed: Sep. 21, 2012
(86) PCT No.: PCT/EP2012/003949

§ 371 Date: Mar. 24, 2014

(30) Foreign Application Priority Data
Sep. 30, 2011 (DE) 10 2011 114 578.1

(51) Int. Cl. B29C 47/08

(52) U.S. Cl. CPC B29C 47/0864; B29C 47/0808
USPC 425/376.1

(57) ABSTRACT

An extruder which has an extruder housing, in which a screw conveyor is located. The extruder housing is located on a support structure that has a housing-type casing. The support structure and the casing are formed from an integral, sealed jacket, designed as a self-supporting shell with at least one access opening on the underside. The opening can be covered by at least one base plate.

The invention relates to an extruder comprising an extruder housing in which a screw conveyor is disposed, wherein the extruder housing is disposed on a supporting structure having a housing-like casing.

An extruder is a conveying device which by means of a screw conveyor presses a solid, liquid or powdery medium, in particular under pressure and at high temperature, out of a shaping opening. In this context, a distinction can be drawn between processing extruders and compounding extruders. A processing extruder is used substantially for shaping, while a compounding extruder is used for chemical and/or physical modification, for example for the mixing, degasification or investigation of substances. According to the invention, both types of extruders should be jointly included.

An extruder of standard construction possesses an extruder housing, in which a mixing or feed channel for the medium to be conveyed and extruded is configured. In the feed channel is disposed, in a tight fit, at least one screw conveyor, which is rotationally driven, whereby the medium is transported along the feed channel.

The extruder housing is supported on a ground surface by a supporting structure, which is usually of frame-like or stand-like configuration, the supporting structure possessing a housing-like casing. The casing is usually formed by a plurality of individual metal, plate-like casing parts, which are detachably attached to a supporting structure. Through the detachment of individual or all casing parts, it is possible for a user to have access to the functional subassemblies disposed behind the casing, for example a drive device, an electronics device or a heating and/or cooling device, in order to be able to repair or exchange these in the event of a breakdown.

If an extruder of said construction is used, for example, in a clean room in production in the pharmaceutical industry, there is the danger of pollutants being deposited in the joints which form the individual casing parts with one another or with the underlying supporting structure, which is unacceptable for hygiene reasons. Moreover, the cleaning of a corresponding extruder is relatively complex, since the casing parts must be detached and cleaned individually. Spraying with a liquid detergent or disinfectant is only very limitedly possible, since there is here the danger of the detergent or disinfectant impairing or disabling the functional subassemblies and, in particular, the electronics device.

The object of the invention is to provide an extruder of the stated type, in which an accumulation of pollutants is as far as possible avoided and which can be easily cleaned.

This object is achieved according to the invention with an extruder having the features of claim 1. It is here provided that the supporting structure and the casing are formed by a one-piece, sealed hood, configured as a self-supporting load-bearing shell, which has at least one access opening on the bottom side, which can be covered by means of at least one base plate.

According to the invention, the hood is configured as a self-supporting load-bearing shell, so that a further substructure can be dispensed with and the hood itself forms the supporting structure and the casing and rests directly on a ground surface and absorbs and diverts the forces. In addition, the hood is of sealed configuration, which means that, on its top side and its side faces, it offers no access to the interior which it encases. Through the access opening configured on the bottom side, a user can gain access to the interior or to the subassemblies which are arranged there. It is thereby possible to spray or rinse the hood on the outer side or on the top side with a liquid detergent or disinfectant and thus easily remove any adherent pollutants. Through the sealing of the hood, an intrusion of the detergent or disinfectant into the interior is reliably avoided.

The hood is preferably configured such that it is gapless and jointless on the outer side, so that pollutants cannot be deposited.

Functional subassemblies of the extruder can be attached to and mounted on the hood, these being constituted, for example, by a drive device for the screw conveyor and/or by an electronics device for controlling individual operating states of the extruder and/or by a heating and/or cooling device for controlling the temperature of the extruder housing and/or by a mains power pack for the power supply.

In the fitted state, the at least one base plate preferably fully covers the bottom-side access opening, wherein a seal can be arranged between the base plate and the marginal region of the access opening, which marginal region is part of the hood.

The base plate is connected to the hood, preferably detachably. In order to obtain access to the interior of the hood, the user releases the connection between the base plate and the hood and removes the base plate, whereby the access opening is exposed. For this purpose, he can either tilt the extruder through 90°, so that the base plate, and thus the access opening, is laterally accessible, though it is also possible to raise the extruder to the point where the user can get under the extruder and from there has access to the base plate.

The base plate can be of multipart configuration, though in a preferred embodiment a single base plate is provided, so that the user can release this very easily and quickly.

The hood can be formed of metal parts, and in particular metal sheets, which can be jointlessly connected to one another to form a one-piece, monolithic body and which are welded together, for example. Alternatively, it is possible for the casing to be formed from a single shaped metal part, for example a sheet metal blank.

Within the interior of the supporting stand, which interior is encased by the hood, the functional subassemblies of the extruder can be arranged. These can be constituted, for example, by a drive device for the screw conveyor and/or by an electronics device for controlling individual operating states of the extruder. Furthermore, it is possible for these to be constituted by a heating and/or cooling device of known construction, with which the extruder housing can be cooled and/or heated, i.e. temperature controlled, in different sections. In addition, a corresponding functional subassembly can be formed by a mains power pack for the power supply. Said functional subassemblies can either be fitted directly on the inner side of the hood, where necessary with the holders placed in-between, or alternatively it is also possible, however, for at least some of said subassemblies to be disposed on the base plate.

Usually, an extruder is equipped with an indicator device in the form of a display or an indicator and control unit, for example in the form of a so-called touch screen, with which the user, during operation of the extruder, can set and monitor specific operating states and can read off measurement results. A corresponding display can be arranged as a single component remote from the extruder, though in a preferred embodiment of the invention it is provided that a corresponding display is inserted or integrated in a sealed manner in the wall of the hood. Here too, the design is such that the hood, together with the display, can be sprayed from the outside with a liquid detergent or disinfectant, without risk of damage to the display. Where necessary, the display can also be disposed behind a sealingly mounted transparent plate.

The heating and/or cooling device can be disposed inside the hood beneath the extruder housing, so that only the hood is arranged between the extruder housing and the heating and/or cooling device. Alternatively, it is also possible, however, for a recess to be configured in the wall of the hood, in which recess the heating and/or cooling device is inserted in a sealed manner, so that the extruder housing can rest directly on the heating and/or cooling device.

Further details and features of the invention can be seen from the following description of an illustrative embodiment with reference to the drawing, wherein:

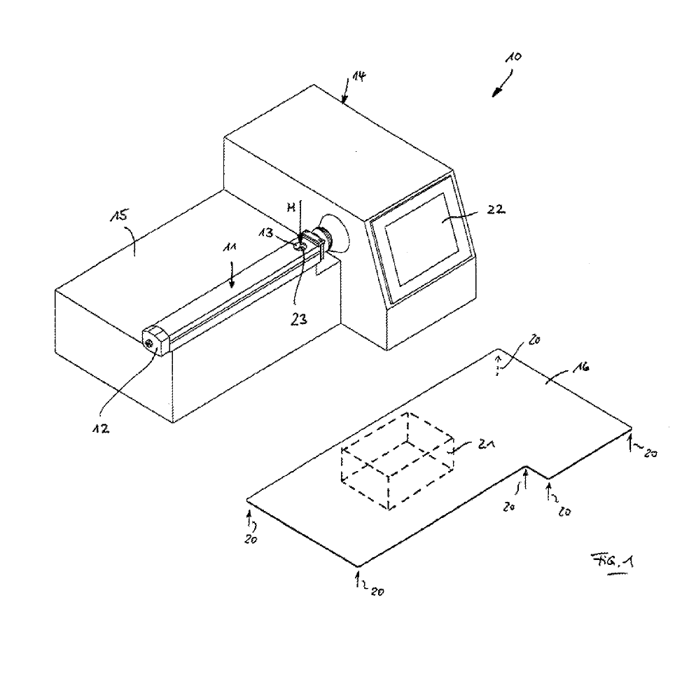

FIG. 1 shows a schematic perspective representation of the extruder with removed base plate, and

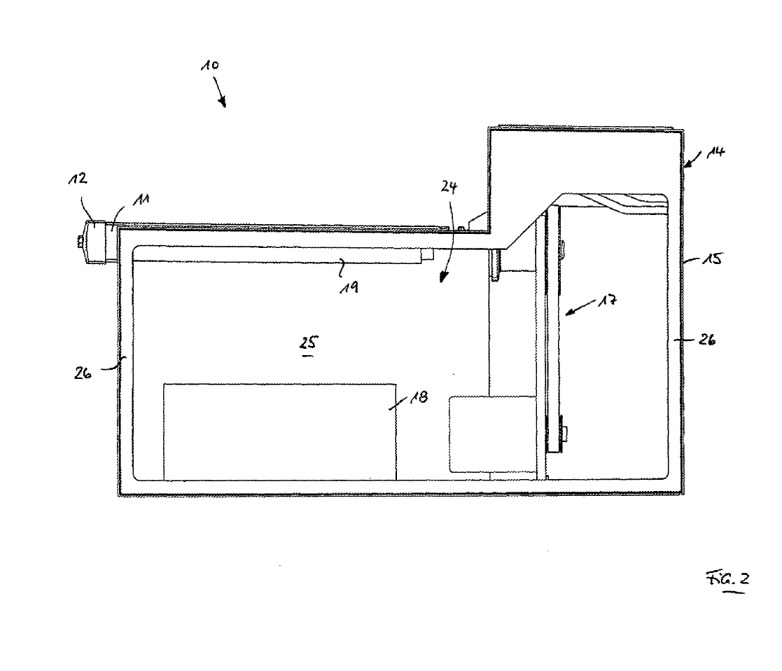

FIG. 2 shows a bottom view of the extruder with removed base plate.

An extruder 10 represented in the figures possesses an elongate extruder housing 11 of standard construction, in which a screw conveyor 23 is disposed. At its one axial end the extruder housing 11 possesses a die 12, and in the region of the opposite axial end is provided a fill opening 13, through which a material to be extruded can be fed, as is indicated by the arrow M.

The extruder housing 11 is seated on a supporting structure 14, which is designed as a self-supporting load-bearing shell in the form of a one-piece, sealed hood 15. The hood 15 is formed from a plurality of metal parts and, in particular, special-steel sheets, which are welded jointlessly together. On the bottom side of the hood 15 is configured an access opening 24 to the interior 25 encased by the hood 15. The hood 15 is wrapped all the way around apart from the bottom side, so that around the access opening 24 is formed a consistently circumferential marginal region 26, which serves as a bearing surface for a one-piece base plate 16, which, by means of fastening means 20 (represented only schematically), in particular screws, can be mounted from below onto the casing 15 and connected thereto, so that the access opening 24 is fully covered.

In the interior 25 of the hood 15, various functional subassemblies of the extruder 10, namely a drive device 17 for the rotary drive of the screw conveyor 23 and an electronics device 18 for controlling or regulating operating states of the extruder 10, are arranged. In addition, in the interior 25 is arranged a cooling and/or heating device 19, which is positioned such that the extruder housing 11 rests on the cooling and/or heating device 19, with the wall of the hood 15 placed in-between.

A further functional subassembly 21, which in FIG. 1 is shown only in dashed representation, can be disposed on the base plate 16.

A display 22 is inserted in a sealed manner in the hood 15, so that it is visible from outside.

If the user must have access to the functional subassemblies disposed in the interior 25 of the hood 14 or on the base plate 16, he releases the fastening means 20 with which the base plate 16 is connected to the hood 15.

Following removal of the base plate 16, he is afforded the possibility of accessing the functional subassemblies through the access opening 24, as can be seen in FIG. 2.

Since the supporting structure is configured as a one-piece sealed hood, gaps and joints, in which pollutants can be deposited, are as far as possible avoided. Because of the sealing and due to the arrangement of the access opening 24 on the bottom side of the hood 15, it is possible, moreover, for the user to wash down the extruder, where necessary following detachment of the extruder housing 11, with a liquid detergent and/or disinfectant, and thereby clean and disinfect the same, without the risk of impairment of the functional subassemblies, and in particular the electronics device 18, disposed in the interior 25.

1. An extruder comprising an extruder housing in which a screw conveyor is disposed, wherein the extruder housing is disposed on a supporting structure having a housing-like casing, characterized in that the supporting structure and the casing are formed by a one-piece, sealed hood, configured as a self-supporting load-bearing shell, which has at least one access opening on the bottom side, which can be covered by means of at least one base plate.

2. The extruder as claimed in claim 1, characterized in that functional subassemblies of the extruder are attached to the hood.

3. The extruder as claimed in claim 2, characterized in that the functional subassemblies are formed by a drive device and/or an electronics device and/or a heating and/or cooling device and/or a mains power pack.

4. The extruder as claimed in claim 1, in that the base plate is detachably connected to the hood.

5. The extruder as claimed in claim 1, characterized in that a single base plate is provided.

6. The extruder as claimed in claim 1, characterized in that the hood is formed of metal parts, which are jointlessly connected to one another to form a one-piece component.

7. The extruder as claimed in claim 1, characterized in that the hood is formed by a single shaped metal part.

8. The extruder as claimed in claim 1, characterized in that functional subassemblies of the extruder are disposed on the base plate and/or within an interior encased by the casing.

9. The extruder as claimed in claim 8, characterized in that the functional subassemblies are formed by a drive device and/or an electronics device and/or a heating and/or cooling device and/or a mains power pack.

10. The extruder as claimed in claim 1, characterized in that a display is inserted in a sealed manner in the wall of the hood.

11. The extruder as claimed in claim 1, characterized in that a heating and/or cooling device, on which the extruder housing rests, is inserted in a sealed manner in the wall of the hood.
